(19) United States
(12) Patent Application Publication
(10) Pub. No.: US 2014/0266068 A1
(43) Pub. Date: Sep. 18, 2014

(54) PULSE BATTERY CHARGER METHODS AND SYSTEMS FOR IMPROVED CHARGING OF LITHIUM ION BATTERIES

(71) Applicant: Evgentech, Inc., Atlanta, GA (US)

(72) Inventors: Timothy J. O'Brien, Shaker Heights, OH (US); Stephen T. Hung, Grosse Pointe Park, MI (US); George Thomas, Lawrenceville, GA (US)

(73) Assignee: Evgentech, Inc., Atlanta, GA (US)

(21) Appl. No.: 14/210,101

(22) Filed: Mar. 13, 2014

Related U.S. Application Data
(60) Provisional application No. 61/782,897, filed on Mar. 14, 2013.

(51) Int. Cl. H02J 7/00; B60L 11/18

(52) U.S. Cl. CPC H02J 7/0093; B60L 11/1809
USPC 320/139

(57) ABSTRACT

The inventions herein relate to devices and methods to impart charge to lithium ion battery cells. Still further, the present invention incorporates to pulse charging methods and systems related thereto that provide improvements in charging speed, efficiency and additional benefits.

### CROSS REFERENCE TO RELATED APPLICATIONS

This application claims priority to U.S. Provisional Application No. 61/782,897, having a filing date of Mar. 14, 2013. This referenced provisional application is incorporated herein in its entirety by this reference.

### FIELD OF THE INVENTION

The inventions herein relate to devices and methods to impart charge to lithium ion battery cells. Still further, the present invention incorporates pulse charging methods and systems related thereto that provide improvements in charging speed, efficiency and additional benefits.

### BACKGROUND OF THE INVENTION

Inadequacy of battery charging processes, especially in lithium ion (“Li-ion”) batteries, is a critical problem today. Generally speaking, while the construction of and chemical aspects of Li-ion batteries have progressed significantly since their market introduction in the early 1990's, the methods used to charge them have not changed markedly. This lack of technical progress in battery charging is felt more acutely today as society becomes more reliant on Li-ion batteries to power a myriad of mobile devices and vehicles not only in the U.S., but throughout the world.

The most prevalent method used to charge Li-ion batteries today is commonly termed “constant current/constant voltage” (“CC/CV”). A representative prior art CC/CV charging process is shown in FIG. 1. Here, charge is applied in a constant current as long as the battery voltage remains below about 4.2 V, which is the rated Vₘₐₓ for this cell. If the Li-ion cell exceeds its rated Vₘₐₓ, dangerous conditions may result or, at a minimum, the battery may quickly fail. To mitigate the effects of constant current charging, charging current will taper to maintain a constant voltage; in other words, charging will switch from the constant current portion (“CC”) to the constant voltage (“CV”) portion. Maintaining the cell at constant voltage necessarily results in significant reduction in the Li-ion battery charging rate.

Practically speaking, CC/CV charging of a Li-ion battery cell means that the battery will acquire about 60-80% state of charge (“SOC”) during the CC portion. The SOC level at which transition from CC to CV occurs depends on a number of factors, including the electrode configuration and chemical composition. For the specific prior art Li-ion charge process shown in FIG. 1, CC/CV charging of the 1000 mAh cell mobile device battery at the stated 1 C rate progresses for about 40 minutes at constant current to result in about 60% SOC, at which time the constant voltage portion commences and current decreases. After about 1 hour of total charging time—about 20 minutes of constant voltage—this cell reaches about 85% SOC; however, it takes close to 2.5 hours for the cell to reach 100% SOC using CC/CV charging. A greater than 2 hour total charging time for Li-ion “energy” batteries to attain 100% SOC is the status quo today.

Somewhat counterintuitively, increasing the current does not greatly hasten attainment of the full % SOC. The battery reaches the voltage peak (i.e., approaches Vₘₐₓ) more quickly at application of higher current and, therefore, the constant voltage portion commences earlier. It then follows that the total time required to achieve 100% SOC will depend on the duration of the constant voltage step. The rate at which current is applied simply alters the time required for each stage. While high current can quickly fill the battery to about 70% SOC, the remaining battery capacity will be “left on the table” if the charging process is terminated at this time. If the full capacity of the Li-ion battery is desired, the user must leave the battery plugged into the charger so the constant voltage period can be completed. Put another way, the voltage response invariably resulting when a high charging current is applied to Li-ion batteries using status quo charging processes requires a tradeoff between % SOC acquisition and the ability to leverage the full available capacity of the battery to power the device (or vehicle) in which the battery is used. If one wishes to have a short charging time, one must accept less than 100% SOC; if one wishes to utilize the full capacity of the battery, one has to accept extended charging times.

As noted, for users of today's mobile devices, such as smartphones, the characteristic Li-ion battery voltage response results in a full charge requiring up to 3 hours. While the device software often indicates that the battery is at about 100% charge in about an hour, users do not actually obtain full capacity in this time, and the user will experience the need to recharge their device more frequently due to the battery having only partial capacity. Moreover, this type of battery—sometimes called an “energy” battery—is intended to provide long device use times, while still at the same time being lightweight and small to ensure appropriate use in mobile devices. Such requirements restrict the ability to use faster charging Li-ion batteries. Accordingly, fast charging is not readily available to users of mobile devices today and users must choose to either charge their batteries for longer times to enable longer periods of use or they must charge their batteries frequently and lose mobility.

Similar to “energy” batteries used for mobile devices, Li-ion electric vehicle (“EV”) battery packs in use today utilize CC/CV charging processes to achieve 100% SOC. These high rate Li-ion “power” batteries are capable of accepting charge at a higher rate than their “energy” battery counterparts, however, the trade-off for this higher charging rate is lower energy density and higher cost.

Typically, an EV user desires to achieve as much SOC as possible—which equates to vehicle range—in the shortest possible time period, so it is common for EV battery pack charging to occur at the fastest available rate given the charging system available. Level 1 charging, which uses 110 V household-type power outlets, is typically used to charge smaller battery packs such as that in the Chevy Volt®. Level 2 charging, which uses 240 V power outlets, is commonly used to charge larger batteries in household settings, as well as in public charging stations. However, for most EV battery packs, Level 2 charging will take 4 or more hours to achieve significant SOC/vehicle range from a single charging event.

Many commentators believe that widespread availability of low cost DC fast charging stations will be needed to accelerate adoption of EVs in the US. Accordingly, a DC charging infrastructure is now being established throughout the U.S using DC fast charging equipment (typically 480 V AC input). These high rate chargers can markedly improve charging speeds. However, much confusion exists in regard to EV fast charging times today because there is no universally agreed-to protocol to measure charging performance or to describe battery capacity. Instead, each manufacturer reports charging performance using information tailored for its specific marketing efforts. Nevertheless, a DC fast charger generally can add about 60 to 80 miles of range to a light duty PHEV or EV in about 20 minutes.

More specifically, as reported by the manufacturer, a Tesla Motors® SuperCharger station can charge to 50% of the rated battery capacity of the Model S 85 kWh battery—or 150 miles—in about 20 minutes and 80% in 40 minutes; however, it takes fully 75 minutes to achieve 100% SOC. This charging behavior is shown in FIG. 2, where the characteristic voltage behavior resulting from application of a high charging rate is shown by the deviation of the SOC curve from linear after the battery reaches 50% SOC. Tesla Motors' marketing materials indicate that charging of the final 20% SOC takes approximately the same amount of time as the first 80% SOC due to a necessary decrease to charging current to help top off the cells. As stated in Tesla Motors marketing literature: “It's somewhat like turning down a faucet to fill a glass to the top without spilling.” Put another way, while Tesla Motors' SuperCharger stations can supply the necessary power to fully charge the battery pack in about 40 minutes, the voltage response that invariably results from application of a high constant charging current does not allow the battery to be charged to 100% SOC unless the charging process is extended to more than 1 hour.

Similarly, a car configured for use with a CHAdeMO DC fast charging system, such as that used with the Nissan Leaf®, can recharge from empty to 80% SOC in about 30 minutes. Reportedly, the Leaf does not allow the battery to be charged beyond 80% SOC, presumably due to manufacturer's concerns regarding voltage behavior upon repeated fast charging to high SOC percentages.

The behavior of Li-ion EV battery packs in DC Fast Charging comports with the charging process shown in FIG. 1 in that application of a high rate constant current causes a voltage response that prevents charge from being accepted by the battery at the highest application of constant current for extended periods. Certainly, each automotive OEM seeks to extract as much performance as possible using sophisticated battery management systems and other types of power controls. However, by using conventional DC fast charging frameworks, the % SOC achievable is limited by the inherent voltage behavior of the battery resulting from application of fast charging.

The voltage behavior resulting from constant current fast charging also negatively influences EV performance in ways that impact the consumer beyond charging speed delays and % SOC concerns, namely in relation to battery sizing and the downsides related thereto.

As is well-known, today's high cost of Li-ion batteries makes EVs much more expensive than comparable gasoline-powered vehicles. Overall cost of the battery is, of course, directly related to the materials used to fabricate the battery. To improve overall performance of the EV, many OEMs have elected to oversize EV battery packs. For example, in a Chevy Volt®, about 20% of the battery is not considered when capacity-related specifications are reported, which means that the rated capacity of the Volt battery pack is about 20% less than the actual capacity as measured by the materials used in the battery pack. While actual data about other battery packs is hard to come by due to the proprietary nature of EV batteries, it is generally understood by experts that such oversizing is present in all EVs today. Certainly, some of the oversizing results from the need to keep discharge/driving behavior within a required % SOC where driving operation (i.e., discharge behavior) is more consistent. However, much of today's battery oversizing is also conducted to provide additional battery material that will become usable for power when battery % SOC begins to decline over the required life of the battery pack (currently 10 years).

Even assuming that oversizing battery packs does not add cost to the EV (that is, assuming that marked price reductions will be achieved in the near future), larger-than-necessary battery packs impact available consumer space and increase vehicle weight while not adding any additional range. If Li-ion EV battery packs could be charged faster without causing as much stress to the Li-ion battery as that seen from conventional DC fast charging, there would be less need to oversize the battery pack. This would enable additional design freedom for EV OEMs (e.g., space for passengers and luggage) and would also allow modest additional vehicle range at no cost due to lower battery weight. Perhaps more importantly, keeping battery size and/or footprint the same as today could allow the entire battery capacity to be used so as to provide additional vehicle range without any modification to the existing battery materials. Such a large increase in range on an essentially cost neutral basis could be significant in the EV marketplace.

The inability of Li-ion batteries to accept high current for an extended period of time without experiencing unacceptable voltage responses is also relevant to regenerative braking efficiency. The energy capture efficiency from vehicle momentum is directly related to the ability of the battery to accept the energy at the currents provided during vehicle deceleration. It is this charged battery that, in turn, powers the vehicle's electric traction motor. In an all-electric vehicle, this motor is the sole source of locomotion. In a hybrid, the motor works in partnership with an internal combustion engine. However, this motor is not just a source of propulsion—it is also a generator. If a Li-ion battery could accept an increased charging rate while attaining higher SOC levels than possible today using conventional charging methods, energy capture would be greater and the battery would be charged more fully during driving. In short, the ability to apply a higher charging rate to a battery from each regenerative braking event could allow smaller gasoline-power motors to be used to provide required power to the vehicle, thus further improving emissions reductions seen with PHEV adoption.

There have been efforts to improve the charging behavior of Li-ion batteries given their importance to consumers today and in the future. Battery management systems and software algorithms, usually in combination with more advanced and expensive chargers, can allow some charging speed improvements. However, improvements to date have been only modest. For most applications, the charging speed increases achievable with use of conventional fast charging processes do not justify the added cost, complexity and battery damage that invariably result.

Some recently announced battery chemistries are reported to provide somewhat faster charging. However, these likely will not gain broad utility in the marketplace at least because modifications that enable faster charging generally reduce energy density. Researchers are also identifying new electrode configurations and the like that allow faster charging, but batteries containing these features are many years from being ready for the marketplace, if they ever are at all, due to the parallel need to fund, develop and validate corresponding production facilities and tools.

To summarize, the voltage behavior that results when constant current is applied to batteries at high rates negatively influences performance in a number of dimensions. A battery charging process that allowed high rate charging while at the same time substantially reducing attendant voltage response would improve Li-ion battery performance.

It would be highly desirable to obtain improvements in Li-ion battery charging without the requirement to modify the chemistry of the battery or without making other, often expensive and complex, modifications to the battery, device or vehicle. Still further, it would be desirable to be able to provide faster charging and less damaging charging of existing Li-ion batteries without causing battery damage seen with prior art fast charging methodologies.

The present invention provides these, as well as other, needed benefits.

### SUMMARY OF THE INVENTION

The present invention comprises charging methodology that allows Li-ion cells to be charged using high effective charging rates during substantially the entire charging process. Still further, the present invention comprises methods and battery charging systems suitable for providing such charging methods wherein a plurality of charging pulses is applied to a Li-ion battery at an average rate of at least about 1 C or greater, wherein the plurality instantaneous open circuit voltages (OCVᵢₙₛₜ) existing during the charging process remain below Vₘₐₓ for substantially the entire duration of the charging pulse application. Unlike other methods of charging Li-ion batteries at comparably high rates, batteries charged according to the methodology herein are characterized by a substantial reduction of the characteristic voltage response that requires current to be reduced after the battery reaches higher % SOC. A wide variety of Li-ion battery cells can be charged in accordance with methods and systems of the present invention including, but not limited to, batteries used to provide power for electric vehicles, automated guided vehicles, robots, mobile devices and wearable devices.

Still further, the plurality of voltage pulses applied to the battery cells in accordance with the invention herein comprises voltage pulses. The voltage pulse can further comprise an offset voltage, a duty cycle and a frequency. In further aspects, the present invention comprises battery charger systems configured to suitably provide the inventive charging pulses.

Additional advantages of the invention will be set forth in part in the description that follows, and in part will be apparent from the description, or may be learned by practice of the invention. The advantages of the invention will be realized and attained by means of the elements and combination particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 illustrates a prior art CC/CV battery charging process applied to a 1000 mAh Li-ion mobile device type battery.

FIG. 2 illustrates an exemplary prior art DC fast charging process for the Tesla Motors® 85 kWh Model S, a current commercial electric vehicle.

FIGS. 3a and 3b are prior art exemplary equivalent circuit battery models from the literature that include models of battery internal impedance.

FIG. 4 includes three conceptual sketches, 4a, 4b, and 4c (not to scale), of various aspects of charging frameworks according to the present invention.

FIG. 5 is an exemplary implementation of the inventive charging process.

FIG. 6 is an exemplary OCV estimation protocol in an analog implementation of the inventive charging process.

FIG. 7 is an exemplary offset voltage reference stage in an analog implementation of the inventive charging process.

FIG. 8 is an exemplary voltage summation stage in an analog implementation of the inventive charging process.

FIG. 9 is an exemplary voltage limiting stage in an analog implementation of the inventive charging process.

FIG. 10 is an exemplary power stage setup in an analog implementation of the inventive charging process.

FIG. 11 is an example of the inventive charging process conducted at about 1 C on an “energy” battery with the discharge behavior at 1 C.

FIG. 12 is a comparative example of a CC/CV (with 1 C CC portion) charging process conducted on an “energy” battery with the discharge behavior at 1 C.

FIG. 13 is a comparison between the charging times for the inventive process and CC/CV process of FIGS. 11 and 12.

FIG. 14 is an example of the inventive charging process conducted at about 2 C on a “power” battery with the discharge behavior at 1 C.

FIG. 15 is a comparative example of a CC/CV charging process (with 2 C CC portion) conducted on a “power” battery with the discharge behavior at 1 C.

FIG. 16 is a comparison between the charging times for the inventive process and CC/CV process of FIGS. 14 and 15.

FIG. 17 is an example of the inventive charging process conducted at about 4 C on a “power” battery.

FIG. 18 is a comparative example of a CC/CV charging process (with 4 C CC portion) conducted on a “power” battery.

FIG. 19 presents a prophetic example of an estimated comparison of the inventive charging process in a commercial electric vehicle in comparison to a prior art DC fast charging process.

### DETAILED DESCRIPTION OF THE INVENTION

Many aspects of the disclosure can be better understood with reference to the drawings presented herewith. The components in the drawings are not necessarily to scale, emphasis instead being placed upon clearly illustrating the principles of the present disclosure. Moreover, in the drawings, like reference numerals designate corresponding parts throughout the several views. While several implementations are described in connection with these drawings, there is no intent to limit the disclosure to the implementations or implementations disclosed herein. To the contrary, the intent is to cover all alternatives, modifications, and equivalents.

The term “substantially” is meant to permit deviations from the descriptive term that do not negatively impact the intended purpose. All descriptive terms used herein are implicitly understood to be modified by the word substantially, even if the descriptive term is not explicitly modified by the word “substantially.”

“Battery” means an electrochemical battery or electrochemical cell. As would be appreciated by one of ordinary skill in the art, a battery is used to store energy for use in, for example, a device or vehicle. “Battery pack” is a group of individual electrochemical batteries or electrochemical cells arranged in series and/or in parallel. The words “battery” and “cell” may be used together or individually herein. The battery charging method and systems herein can suitably be used to charge battery packs.

“Battery charger system” means a device, apparatus or method for providing electrical energy to a battery cell and/or pack for storage and use at a later time by a device or vehicle configured to be powered by such Li-ion battery cells and/or packs. The battery charger system of the present invention can comprise one or more implementations as discussed herein. The battery charger systems of the present invention can also comprise any suitable configuration (e.g., analog, microprocessor controlled, etc.) that will allow the charging processes of the present invention to be suitably conducted.

“State of charge” (“SOC”) is a fraction calculated as the amount of charge in the battery at a particular time divided by the maximum amount of charge that the battery can store. SOC is typically indicated as a percentage.

“Open circuit voltage” (“OCV”) means the electrical potential between two terminals of a battery when disconnected from any external circuit.

“OCV_{eq}” means the equilibrium open circuit voltage. As is known by those of ordinary skill in the art, the OCV_{eq} depends substantially on SOC. The OCV of a battery during charge or discharge deviates from OCV_{eq} due to the effects of cell polarization. When charging or discharging ceases, the OCV measured for the battery changes over time and converges to a long-term value, OCV_{eq}, as polarization dissipates.

OCVᵢₙₛₜ is an instantaneous value measured for OCV. Generally, if OCVᵢₙₛₜ is measured a short time after charging or discharging has ceased, then OCVᵢₙₛₜ≠OCV_{eq}. During application of the inventive charging pulses, OCVᵢₙₛₜ will vary, as least in relation to % SOC. As such, each charging process will comprise a plurality of OCVᵢₙₛₜ.

Battery impedance (“Z_{Batt}”) means that aspect of a battery that behaves as an electrical impedance in series with an ideal voltage source whose output voltage is OCV_{eq} as defined herein below. This battery impedance comprises the Thevenin equivalent impedance of the battery modeled as an electrical component and arises from internal components of the battery, in particular, from the materials of construction of the battery and the physical configuration of such materials in the battery. The impedance may be modeled as a battery series resistance and a battery complex impedance network, as diagrammed in FIG. 3a.

The battery series resistance (“Rₛ”) comprises the part of the battery impedance that behaves as a resistance in series with, and not parallel to, any reactive components of the battery impedance (such as equivalent capacitances or inductances). This resistance is comprised principally of the resistances of physical components and particles that make up the battery, the contact resistances between the components or particles, and the electrolyte resistance. The battery series resistance is one of several battery characterization parameters that battery manufacturers may supply to producers integrating batteries into end-item products and can be determined by one of ordinary skill in the art according to known methods.

As known, and as represented by the exemplary battery models of FIGS. 3a and 3b, a battery also comprises a number of capacitive features that reside in a complex impedance network topologically in series between the battery series resistance and the Thevinen equivalent ideal voltage source. These capacitive features comprise, for example, the double layer capacitances, C_{dl}, formed at the interface between the electrolyte and the electrodes and a pseudocapacitance, C_{φ}, that arise due to a non-constant functional relationship between applied voltage and state of charge during the battery charging process. Still further, the inventors herein understand, not wishing to be bound by theory, that the capacitances of a battery under charge can be somewhat substantial as discussed elsewhere herein.

“Battery current” (“I_{Batt}”) is the electrical current flowing through the battery. When describing battery charging processes, positive values of I_{Batt} correspond to net electrical current flowing into the positive terminal of the battery, so as to reflect positive progress in the charging process, and negative values of I_{Batt} correspond to net electrical current flowing out of the positive terminal of the battery, as would occur in battery discharge events.

If battery current changes or varies during the window of time of a particular process, the battery process average current, I_{BattPavg}, is the average of battery current across the time window of the entire process. If a battery current varies and the variation has a periodic component, the battery cycle average current, I_{BattCavg}, is the average of battery current across the time window of one cycle of periodicity. If the battery current also has a component of variation that is not periodic, the battery cycle average current may vary from cycle-to-cycle.

“Vₘₐₓ” means an upper limit specified for the maximum voltage to apply to a battery under charge. Battery designers specify Vₘₐₓ by taking into account battery chemistry, the details of construction, the likely charge/discharge regime in use and the consequences of failure. For example, in a typical lithium ion battery used in mobile electronic products (also termed an “energy battery” or “energy cell”), the generally recognized Vₘₐₓ is about 4.3 V or less, and more commonly 4.2 V. Vₘₐₓ is defined for each specific battery chemistry and capacity in accordance with methodologies well-known to those of skill in the art. The value of Vₘₐₓ can be determined according to battery supplier specifications, regulations and standards, and other product development considerations. Determination of Vₘₐₓ is not a part of this invention.

Loaded cell voltage (“V_{Lcv}”) is a voltage generated internally by the cell during charge or discharge comprised of the open circuit voltage and the voltage across the battery complex impedance network, but not including the voltage across the battery series resistance. V_{LCV} is the equivalent of OCVᵢₙₛₜ when battery current flows in closed circuit conditions, and conceptually, one would, for example, measure the voltage from node x to node y in the equivalent circuit of FIG. 3a in order to determine its value. Because nodes x and y of FIG. 3a are actually internal to the battery cell, it is difficult to actually measure V_{LCV}. However, under conditions when there is little potential drop across the internal impedance of the battery:

V_{Batt}≈V_{LCV}≈OCVᵢₙₛₜ,

where “battery voltage” (“V_{Batt}”) is the voltage measured across the battery terminals at any time, with negative reference assigned to the negative terminal of the battery. In real time during the application of the inventive charging pulses V_{Batt} can also comprise the sum of the loaded cell voltage, V_{LCV}, and the applied offset voltage of the inventive process. In general terms, the V_{Batt} measured at any one time is the sum of V_{LCV} plus the battery current, I_{Batt}, times the battery series resistance, Rₛ, or:

V_{Batt}=V_{LCV}+(I_{Batt}×R_{S})

If no current flows through the battery then:

V_{Batt}=OCVᵢₙₛₜ

To illustrate, if a Li-ion battery is charged with the inventive charging pulse applied at an effective current rate of 1 C along with an offset voltage of 300 mV, the measured voltage V_{Batt} will be the sum of loaded cell voltage, V_{LCV}, and the applied offset voltage. This V_{Batt} may exceed the battery's Vₘₐₓ (e.g., 4.2 V) at any one time during the inventive charging process. With the 300 mV offset voltage application, if V_{Batt} measured in real time is, for example, 4.35 V or greater, the V_{LCV} will nonetheless be below Vₘₐₓ. This is further illustrated in the Examples herein.

Under charging conditions: V_{Batt}>V_{LCV} and the incremental voltage of V_{Batt} above OCV is commonly referred to as “overpotential.”

“Charging pulse” means any pulse of current or voltage of any shape applied across the battery terminals. A charging pulse has a “pulse period” comprising an “ON-time,” also known as a “pulse width,” during which current is supplied to the battery to increase the SOC, and an “OFF-time,” during which no current is supplied to the battery and the external circuit may present substantially the nature of an open circuit to the battery. The charging pulse may also be characterized in terms of “duty cycle.” “Duty cycle” is the fraction of time that a system is in an “active” state. For example, in an ideal pulse train (one having rectangular pulses), the duty cycle is the pulse width divided by the pulse period. For a pulse train in which the pulse width is 1 μs and the pulse period is 4 μs, the duty cycle is 0.25. The duty cycle of a square wave is 0.5, or 50%.

“Offset voltage” is the incremental amount of voltage applied to the battery in accordance with the inventive charging methods herein. Offset voltage is illustrated, for example, in FIGS. 4a, 4b and 4c.

The “charging pulse frequency” is the reciprocal of the charging pulse period.

A battery “voltage peak” is the portion of a charging pulse associated with ON-time during which the battery voltage is substantially at the maximum voltage level attained during that ON-time. The “peak voltage” is the maximum voltage level attained during a voltage peak.

A battery voltage “trough” is the portion of a charging pulse associated with OFF-time during which the battery voltage is substantially at the minimum voltage level attained during that OFF-time and at which time the external battery charging circuit is presenting to the battery the nature of an open circuit.

In broad terms, the present invention comprises charging methodologies and systems incorporating such charging methodologies that allow Li-ion cells to be charged using high effective charging rates during substantially the entire charging process. Still further, the present invention comprises methods and battery charging systems suitable for providing such charging methods wherein a plurality of charging pulses are applied to a Li-ion battery at an average rate of at least about 1 C or greater, wherein OCVᵢₙₛₜ remains below Vₘₐₓ for substantially the entire duration of the charging pulse application.

Unlike other methods of charging Li-ion batteries at comparably high rates, batteries charged according to the methodology herein can be characterized by a substantial reduction of the characteristic voltage response seen when charging Li-ion batteries at high rates as compared to prior art constant current charging methodologies. The unique and beneficial voltage response of batteries charged in accordance with the present invention permits charging of Li-ion batteries to significant % SOC in 1 hour or less. In further aspects, the present invention comprises a charging methodology and systems incorporating such charging methodology that allows charging of Li-ion batteries at 1 C or greater to a % SOC of at least about 80%, or at least about 85%, or at least about 90% or at least about 95% or up to about 100%, substantially without need for application of a constant voltage portion.

In some aspects, the inventive charging methodology comprises a charging pulse. Still further, the charging pulse of the present invention comprises a voltage pulse. The charging pulse of the present invention can consist essentially of a voltage pulse. Yet further, the voltage pulse of the present invention comprises one or more of an offset voltage, a frequency and a duty cycle as set forth in more detail herein. Still further, the voltage pulse of the present invention consists essentially of a voltage pulse. The voltage pulse of the present invention can further consist essentially of an offset voltage, a frequency and a duty cycle.

As would be understood by those of ordinary skill in the art, battery capacity, C, can be expressed in Amp-hours (Ah) or milliamp-hours (mAh). Battery charging rate (C-rate) is often described in normalized units of capacity per hour. For example, a 1000 mAh battery charging with a charging current of 1000 mA (or 1 A) would be charging at a C rate of 1 C. For a 100 mAh capacity battery, the current corresponding to 1 C is 100 mA (or 0.1 A). The present invention supports charging of Li-ion battery cells at effective C rates of at least about 1 C or at least about 1.5 C or at least about 2.0 C or at least about 2.5 C or at least about 3.0 C or at least about 3.5 C or at least about 4.0 C or at least about 4.5 C or at least about 5.0 C or greater substantially without the battery experiencing deleterious effects normally expected from prior art fast charging processes. Such deleterious effects include, but are not limited to, voltage rise greater than Vₘₐₓ, side reactions, unacceptable temperature increases or even fires.

As would be recognized by those of skill in the art, the characteristic voltage behavior occurring in Li-ion batteries resulting from application of high constant charging current requires the current to be greatly reduced during the later stages of charging or even be terminated to keep the battery voltage from exceeding Vₘₐₓ. A typical prior art voltage response of a 1000 mAh mobile device battery—that is, an “energy” battery—is shown in FIG. 1. If the battery charging process is terminated due to the battery voltage attaining Vₘₐₓ, the % SOC of the battery will remain below the available capacity of the battery. In FIG. 1, application of a 1 C charge rate results in about 60% SOC in about 36 minutes (or 0.6 hour). At about 36 minutes, the current decreases and the rate of increase of % SOC similarly declines. At about 1 hour, the battery only has about 80% SOC vs. the 100% SOC if the rate had continued at 1 C for the entire 60 minutes. As seen in FIG. 1, to achieve the full 100% SOC of this battery, the battery must remain connected to the charger for close to 3 hours.

The characteristic voltage response from an exemplary prior art high rate Li-ion battery charging of EV batteries is shown in FIG. 2. In this representation of the charging process of a Model S 85 kWh battery having a reported 300 mile range as reported by Tesla Motors (http://teslamotors/supercharger), one sees that 20 minutes of high rate charging will provide 150 miles of range (i.e., 50% SOC). This amounts to an about 1.5 C charging rate. However, a charge time of 40 minutes is required to attain 240 miles (i.e., 30% more SOC), signifying that the charging rate between 20 and 40 minutes decreases to an average of about 0.9 C. It takes an additional 35 minutes to acquire the final 20% SOC—that is, to achieve the full 300 mile range for the 85 kWh Model S—which means that the C rate for this last charging stage slows to an average C rate of about 0.34 C.

As should be apparent from the data presented for the prior art charging processes in FIGS. 1 and 2, in order to achieve a faster overall charging process, the user must accept a lower available battery capacity, and thus a shorter run time for the device or vehicle being powered by that battery. In other words, to employ a constant high charging rate, the user is required to forego using a portion of the full storage capacity available in the battery. In contrast, if a constant voltage step is applied after the constant current step, more of the available capacity of the battery can be utilized, allowing longer runtime available for the device or vehicle. However, to obtain this full capacity after an initial constant current charging process, the user must accept a longer charging time. Conventional battery charging therefore requires a tradeoff between charging time and battery capacity. Such a trade-off is substantially not required with the charging processes of the present invention.

A wide variety of Li-ion battery cells can be charged in accordance with methods and systems of the present invention including, but not limited to, batteries and battery packs used to provide power for electric vehicles, automated guided vehicles, robots, mobile devices and wearable devices.

In applying current for charging in accordance with the methodology of the present invention, the appropriate C rate in a particular instance will depend, in part, on the Li-ion battery being charged. For example, for “energy” batteries—that is, those batteries intended for use in mobile and similar devices—conventional constant current processes maintained at over about 1 C gives rise to significant possibility battery failure, either immediately or over continued use. Such “energy” batteries are typically lithium cobalt oxide chemistry, and can be the form of 18650 cells or configured in soft packs. For such batteries, the inventive battery charging process allows the batteries to be charged at an effective charging rate of least about 1 C for substantially all of the duration of the charging process, and beyond the point where the voltage of the battery would exceed acceptable levels in prior art charging methodologies. Still further, with lithium cobalt oxide “energy” batteries, the effective charging rate can be at least about 1 C, 1.25 C, 1.5 C, 1.75 C or 2 C or more for substantially the entire duration of the charging process, where the OCVᵢₙₛₜ remains substantially below Vₘₐₓ for all or substantially all of the charging process. This is in contrast to prior art charging methods in which application of a constant current charge at a rate of about 1 C or greater results in battery OCVᵢₙₛₜ approaching the Vₘₐₓ of the cell at about 60 to 70% SOC. It has surprisingly been found that lithium cobalt oxide cells charged in accordance with the inventive voltage pulse can be charged at a much higher effective C rates without experiencing the heat or voltage increases that are recognized as damaging or dangerous and that prevent these cells from being charged at high C rates unless comprehensive cooling and fireproofing systems are used. One example of such cooling and fireproofing systems is disclosed in U.S. Pat. No. 8,263,250 (assigned to Tesla Motors), the disclosure of which is incorporated herein in its entirety by this reference.

In “power” batteries—that is, those Li-ion batteries intended for use in EVs, robots, power tools and the like—higher C rates can be applied both using conventional constant current processes and with the inventive pulse charging method. These batteries include lithium iron phosphate and the like. For such batteries, the inventive battery charging process nonetheless allows the batteries to be charged at even higher effective rates to achieve higher % SOC than possible with prior art constant current charging processes. In particular, the inventive charging process allows charging of at least about 1 C for substantially all of the duration of the charging process. Still further, with Li-ion “power” batteries, the effective charging rate can be at least about 1 C, 1.25 C, 1.5 C, 1.75 C, 2 C, 2 C, 2.5 C, 2.5 C, 2.75 C, 3 C, 3.25 C, 3.5 C, 3.75 C or 4 C or more for substantially the entire duration of the charging process, where the battery voltage remains substantially below Vₘₐₓ for all or most of the charging process. This is in contrast to prior art charging methods in which application of constant current at a rate of at least about 1 C to 1.5 C or even greater results in a voltage response that requires reduction in the current applied to the battery, as is illustrated in FIG. 2, for example.

An aspect of the present invention relates to the characteristics of the charging pulse applied to the battery. In this regard, the charging pulse applied to the battery during the charging process comprises a plurality of voltage pulses whose application results in the inducement of a battery current pulse as a response to the voltage pulse. Yet further, the charging pulse applied to the battery does not comprise a current pulse of controlled current magnitude that is imposed upon the battery independently of battery voltage. Yet still further, the charging pulse applied to the battery substantially does not switch to a current pulse.

In some aspects of the charging method of the present invention, one or more trough portions of a plurality of charging pulses can each, independently, be characterized as providing essentially an OCVᵢₙₛₜ to the cell for substantially the duration of the time that no charging energy is applied to the battery. When the battery charger system is not transferring energy to the battery, any voltage reading at the battery terminals would be a representation of the open cell potential measured in real time, in other words, the nature of an open circuit would be presented to the battery. In one aspect, such real time voltage measurement is incorporated in the invention herein as OCVᵢₙₛₜ. OCVᵢₙₛₜ can be closely approximated to the loaded cell voltage, V_{LCV}, and therefore it can be stated that V_{Batt} comprises a sum of V_{LCV} and the applied offset voltage at any point in time during application of the inventive charging process.

As used herein, the OCVᵢₙₛₜ typically differs from equilibrium OCV (“OCV_{eq}”), where the latter results by allowing the battery to relax for some time after application of charging pulse is stopped. OCV_{eq} is understood to be generally synonymous with the complete or substantially complete relaxation of transient or non-equilibrium conditions within a battery. An example of a non-equilibrium state would be the presence of a transient concentration gradient in the electrolyte. Reports of the time required to achieve OCV_{eq} vary substantially in the literature, however, it is generally believed that relaxation takes at least seconds, or minutes or even hours to achieve for various battery types.

Still further, it has been found that the beneficial properties of the charging methodology of the present invention can be achieved by applying an offset voltage during the charging process without actual measurement of OCVᵢₙₛₜ. In other words, a constant or substantially constant offset voltage can be applied to the battery during all or substantially all of the charging process, as long as the battery charger system applies a suitable charging pulse to the battery. While measurement of the OCVᵢₙₛₜ and applying an offset voltage in response to each measured OCVᵢₙₛₜ can provide the ability to achieve the benefits of the inventive charging process, the ability to substantially achieve the inventive charging benefits without the need to implement expensive power electronics controls potentially can improve the applicability of the present invention to lower costs applications, such as consumer products.

Whether applied in relation to determination of the OCVᵢₙₛₜ or otherwise, the offset voltage can be kept constant for the entire charging process, or it can be varied. In some aspects, the offset voltage can be about 50 mV, 75 mV, 100 mV, 150 mV, 200 mV, 250 mV, 300 mV, 350 mV, 400 mV, 450 mV, 500 mV, 550 mV, 600 mV, 650 mV or 700 mV greater than the OCVᵢₙₛₜ (or the actual loaded cell voltage (V_{LCV}) while the battery is undergoing charge) where any value can form an upper or lower endpoint as appropriate.

Still further, the offset voltage can comprise any voltage that, when applied in the form of a plurality of charging pulses as described herein, results in the ability to apply a high charging rate (e.g., 1 C or greater) to the battery to allow the voltage to rise in a linear or nearly linear fashion. Still further, the offset voltage can comprise any voltage that, when applied in the form of a charging pulse as described herein, results in the ability to apply a high charging rate to be applied to the battery in a constant rate to achieve at least about 80%, or 85% or 90% or 95% or up to about 100% SOC with the V_{I-Cv} substantially remaining below Vₘₐₓ for substantially the entire charging process. In other aspects, the offset voltage can comprise any voltage that, when applied in the form of a charging pulse as described herein, results in the ability to apply a high charging rate substantially without resulting in the characteristic voltage response requiring application of a constant voltage portion.

A further characteristic of the charging pulse of the present invention relates to the duty cycle. In this regard, the duty cycle can be substantially constant within all or substantially all of a pulse sequence or plurality of pulse sequences that make up a charging operation according to the present invention. In some aspects, the duty cycle of the voltage pulse can be about 99, or 95 or 90 or 85 or 80 or 75 or 70 or 65 or 60 or 55 or 50%, where any value can comprise an upper or lower endpoint as appropriate.

Still further, the duty cycle of the voltage pulses can vary within all, substantially all or during of the charging operation in accordance with the present invention. In a further aspect of the present invention, the duty cycle of each of the charging pulses applied to the battery substantially do not vary during substantially all of the charging process. In a further aspect, the duty cycle of the plurality of charging pulses applied to the battery each, independently, do not vary more than about 1% or 5% or 10% or 15 or 20% during all or substantially all of an entire charging process. In yet a further aspect, there is substantially no pulse width modulation applied to the battery terminals during all or a substantial portion of a charging process. However, one could use pulse width modulation internal to the charger to achieve the voltage(s) applied to the battery terminals during pulse ON-times; i.e., use “very-fine” pulses of a switchmode circuit to construct the broader charging pulses of invention, whose widths, while broader than those of the switchmode circuit, are substantially not determined through pulse width modulation. In some aspects, use of such a switchmode charger could be more power-efficient, and thus be particularly suitable in some applications. Such regulation may not be needed for some applications because a voltage offset pulse can suitably be applied without fine measurement of the real time behavior of the battery under charge.

A further characteristic of the charging pulse of the present invention is frequency. While the frequency may vary depending on the other variables relevant to the charging process of the present invention (e.g., offset voltage and duty cycle), it has been found that periods of less than about 200 or 100 or 50 ms can be particularly suitable to achieve the beneficial effects of the present invention. In particular, the period of the voltage pulse can be equal to or less than about 200 or 100 or 50 or 40 or 30 or 20 or 10 or 1 or 0.1 ms, where any value can form an upper or lower endpoint, as appropriate. The frequency of the inventive voltage pulse can be represented in Hz. In this regard, the frequency of the voltage pulses that make up the plurality of voltage pulses can also be from about 1 to about 200 Hz. Yet further, the frequency of the voltage pulses can be about 1, 5, 10, 25, 50, 75, 100, 125, 150, 175 or 200 Hz, where any value can form an upper or lower endpoint, as appropriate. Still further, the frequency of the voltage pulses can be less than 50 Hz or less than 25 Hz.

In a further aspect, the inventive battery charging process can be voltage regulated with respect to the battery's OCVᵢₙₛₜ for all or substantially all of an application of a plurality of charging pulses, where such plurality of charging pulses is used in a process of charging a battery or a battery pack. This is in contrast to prior art voltage regulated pulse charging processes that are regulated with respect to battery Vₘₐₓ. Such processes are generally current limited and do not provide much improvement in charging rates because, for example, the application of high charging currents in accordance with prior art processes quickly results in Vₘₐₓ being reached or exceeded which, in turn, means that the charging rate must be reduced before the battery cell attains sufficient % SOC.

As currently understood by the inventors herein, the beneficial features of the charging process of the present invention, at least in part, relates to the unique voltage response of the battery undergoing charge from application of the plurality of charging pulses in accordance with the present invention. This voltage response is believed to result in little to no formation of “overpotential” as such term is defined in U.S. Pat. No. 8,368,357, the disclosure of which is incorporated herein in its entirety by this reference. The absence or substantial reduction of overpotential resulting from application of a charging signal means that the method herein substantially does not require the calculation of an “overpotential” as defined in the '357 patent, and adaption of the charging process in response to such measurement. In contrast, in some aspects, the present invention operates to apply to the battery an optimum or substantially optimum amount of offset voltage necessary to induce as a result the efficient and effective charge transfer through and among the various components of a battery as appropriate for each battery in real time.

Existing pulse charging methods, such as that of the '357 patent and those of U.S. Pat. No. 5,694,023 (Podrazhansky et al.) and U.S. Pat. No. 6,040,685 (Tsenter et al.), each of which are incorporated herein in their entireties by this reference, seek to impart charge as quickly as possible before the battery exhibits adverse effects that require dramatic subsequent reduction of charging rate. To accomplish this, prior art methods define various algorithms and/or apply various battery management regimens to minimize adverse effects resulting from charging while also seeking to extract improved charging speeds. The '357 patent asserts that it represents an improvement over prior art methods by recognizing the benefits of controlling overpotential that includes closely monitoring the behavior of the battery during charging. Rather than pre-defining the pulse charging sequence to be applied (see for example, the Podrazhansky '023 patent), the '357 patent seeks to adjust the pulse charging sequence of a battery during charge. The '357 patent method therefore describes “on the fly” modification of a pulse charging sequence based upon calculation of an overpotential in real time, where the overpotential is an adverse consequence of the pulse charging process applied therein, where such overpotential is defined by reference to the battery's Vₘₐₓ.

In contrast, in significant aspects, the method of the present invention operates by referencing the real time voltage of the battery while being charged during application of the inventive charging process herein. An incremental voltage that is “just enough” over this real-time voltage is applied so that minimal overpotential is developed.

How much offset voltage is just enough can be determined a priori in designing a battery charger system in accordance with the present invention such as by using information from equivalent circuit models of a subject battery, or can be determined through use of dynamic feedback of measured battery current, I_{Batt} or measured battery cycle average current, I_{BattCavg}. Still further, the amount of offset voltage needed to achieve the benefits of the present invention can be determined experimentally by varying the various parameters relevant to the inventive charging method (e.g., offset voltage, pulse frequency and duty cycle) for a battery cell, pack or system using methods know to those of skill in the art. Yet further, the appropriate offset voltage level can be determined by estimation from measurement of battery terminal voltage during application of the plurality of charging pulses.

A battery can be modeled using an equivalent circuit comprising standard electrical features. One example of a prior art battery equivalent circuit is shown in FIG. 3A. A second example of a battery equivalent circuit is found in FIG. 3B. The inventors herein have found that the equivalent circuit models of FIGS. 3A and 3B can be used in simulations of the present invention virtually interchangeably, albeit with adjustments to equivalent circuit parameter values to yield approximately similar overall impedance characteristics. Without being bound by theory, and in certain aspects, the inventors hypothesize that the beneficial aspects of the present invention result, at least in part, from leveraging a battery's series resistance and equivalent circuit to influence charging behavior. Unlike the OCV, the series resistance behavior of the battery does not change as substantially as a function of the state of charge for much of the useful range of % SOC, that is, above about 5% or about 10% or about 15% or about 20% or about 25% SOC.

The series resistance of a battery is a property of each specific battery type and design. This value is a known or knowable feature of each battery type. This value is typically provided to battery end-use product integrators/producers by the manufacturer for a specific battery design or even for a specific lot of batteries. If not supplied by the manufacturer, the series resistance of a battery is readily determinable by one of ordinary skill in the art without undue experimentation.

As known, and as represented by the exemplary battery models of FIGS. 3A and 3B, a battery also comprises a number of capacitive features. These capacitive features comprise, for example, the double layer capacitances formed at the interface between the electrolyte and the electrodes and a pseudocapacitance that arises due to a non-constant functional relationship between applied voltage and state of charge during the battery charging process. Still further, the inventors herein understand, not wishing to be bound by theory, that the capacitances of a battery under charge can be somewhat substantial. In some aspects, the capacitances of a battery under charge can be at least about 1 F, 1.5 F, 2 F, 2.5 F, 3 F, 3.5 F, 4 F, or 5 F or even as large as 25 F in some circumstances. In accordance with the pulse charging processes of the present invention, the inventors herein believe that the dissipation of charge from at least some of the capacitive features present in a battery can be very fast (e.g., as low as 20 μs) in the substantial absence of an applied charging pulse. In other words, the inventors have found that application of short duration charging pulses, for example the incremental voltage pulses discussed herein, can impart charge to a battery for storage substantially without also resulting in creation of substantial overvoltage, where such overvoltage is believed to be created in whole or in part by charging of one or more of the capacitive features of a battery. Additionally, the inventors have recognized that the more residual charge remaining on the battery capacitances during a charging process, the more overvoltage remaining in the battery.

In accordance with one aspect of the present invention, the OFF-times substantially allow at least a portion of the capacitive features in the battery to dissipate their accumulated charge(s) at least in part prior to application of a subsequent charging pulse. The inventors hypothesize that the dissipation of accumulated charge during OFF-times is a contributor to the absence or substantial reduction of overpotential in one or plurality of charging pulse applications

In some aspects, by focusing on charging by applying the lowest amount of charging pulse energy needed to impart a suitable charge for a particular battery cell and/or pack, the inventive battery charging process seeks to leverage existing battery internal capacitive features to absorb charging current, while at the same time effectively reducing or eliminating overvoltage-related resistance to charge.

In a feature of the inventive process, a substantially low level of charging of the capacitive features of the battery occurs during application of a single charging pulse. Moreover, the present invention results in a substantially low level of capacitive charging during application of a plurality of charging pulses. It has been discovered by the inventors herein that with this minimum of charging of the capacitive features, a minimum amount of energy will generally be needed to charge the battery effectively and efficiently. Faster overall charging can also occur without substantially without incurring increased temperatures and voltage spikes as compared to prior art charging methodologies. Moreover, long term battery behavior can be improved, such as in less capacity fade over extended use.

In a relevant aspect of the present invention, when the capacitive features of the battery are kept substantially uncharged or, at least, less fully charged than in other rapid or pulse charging methodologies, battery charging can effectively and efficiently result when an applied voltage is sufficient to address the series resistance so that a suitably high average current can be applied to the battery substantially without causing the deleterious effects generally expected from fast charging processes.

In the battery charging process of the present invention, as well as with the attendant battery charging systems, the charging pulse applied to charge the battery can be, in some aspects, characterized as substantially the minimum offset voltage needed to overcome the potential existing in real time.

Suitable operation of the inventive battery charging processes herein generally does not necessitate knowledge of the exact value of Rₛ. As such, I_{BattCavg} in the present invention can comprise the desired cycle average current applied during the ON-time and, accordingly, can be used to approximate the actual instantaneous current, if the charger implementation already measures I_{BattCavg} as a process control variable. I_{BattCavg} can also be estimated from I_{Batt}, if the charger implementation already measures instantaneous current as part of transient process control, as such controls are known to one of ordinary skill in the art. Use of a priori knowledge of Rₛ is only one potential means of reducing charger circuit hardware cost by marginalizing the need for current sensing hardware.

In further aspects, the voltage applied to the battery in the plurality of charging pulses can comprise an instantaneous terminal voltage applied to the battery (V_{Batt}) and can be calculated according to the following formula.

V_{Batt}=I_{Batt}×Rₛ+OCVᵢₙₛₜ and

I_{Batt}=I_{BattCavg}×(pulse period)/(ON-time duration),

wherein the desired [instantaneous] battery current, I_{Batt}, is derived from the desired battery cycle average current, I_{BattCavg}, desired for a particular portion of an overall charging process, Rₛ is internal series resistance as discussed previously, and OCVᵢₙₛₜ is the instantaneous OCV existing in the battery in real time, also as defined previously. In one aspect of the present invention, OCVᵢₙₛₜ can be measured, sensed, estimated or otherwise determined at one or more times, during each of a plurality of OFF-times. The inventors hypothesize that the OCVᵢₙₛₜ will generally be lowest (and more informative) at or near the end of the respective OFF-times—that is, at or near the end of the trough portion of the applied voltage pulses. As such, when OCVᵢₙₛₜ can be measured, sensed, or otherwise determined in the OFF-time, it may be sufficient to acquire information about OCVᵢₙₛₜ only one time during the OFF-time, namely, where such one time is at or near the end of the OFF-time. Since the OCVᵢₙₛₜ can be very closely approximated to V_{LCV}, and the offset voltage applied can be pre-set, in some aspects, the OCVᵢₙₛₜ can be calculated by subtracting the offset voltage from the measured V_{Batt}.

The inventive charging processes can also be suitably obtained by using either instantaneous or cycle average current (or approximation of cycle average current) as a feedback signal to control a voltage source that applies during ON-times the proper voltage to induce the desired instantaneous current subject to the battery charging voltage limitation. In some aspects, use of such dynamic feedback can provide more consistent delivery of cycle average current and incorporation of such capability can be beneficial when the additional cost and package space of incorporating current feedback is appropriate for certain applications.

Regardless of whether an application designer chooses to use OFF-time OCVᵢₙₛₜ estimation and a fixed incremental offset voltage or to use on-time dynamic feedback of battery current information, the periodic OFF-time duration of the inventive voltage pulse can be substantially uniform through the charging process or it can be designed to vary. The duration of the OFF-time can be from about 10 μs to about 10 ms. In some aspects, the duration of the OFF-time can be from about 0.1, 0.5, 1, 2, 5, 7, or about 10 ms.

Optimal ON-time will vary according to battery characteristics. In general, however, longer ON-times could be found to result in greater charge accumulations within the capacitances of the battery internal impedances, and thus higher Vᵣₑₛ levels; shorter ON-times, however, may generally necessitate the use of greater ON-time voltages to achieve greater instantaneous currents in the shorter ON-time. Longer OFF-times may reduce induced current cycle averages (and overall charging rate); while shorter OFF-times may interrupt the opportunities for charge to dissipate from the battery internal impedances.

The inventors have found the inventive charging processes herein to be generally applicable for pulses whose overall periods range from about 100 μs to about 100 ms and whose ON-time duty cycles range from about 50% to about 90%. Still further, the duty cycles of the voltage pulse of the present invention can comprise from about 50, 55, 60, 65, 70, 75, 80, 85, or 90%, where any value can comprise an upper or lower endpoint, as appropriate. Selection of pulse period and corresponding ON-time duty cycle may generally be dependent upon battery characteristics, the desired charging rate, and allowable battery thermal power dissipation rate and is thus dependent, in part, upon the battery and the application in which the battery is to be used.

As would be recognized by those of ordinary skill in the art, Li-ion battery voltage progressively increases as the SOC increases within the range of 0% to 100%. At some point during the charging process of the present invention, the sum of the battery OCVᵢₙₛₜ and the offset voltage reference could exceed Vₘₐₓ. It has been found that as long that the V_{LCV} substantially remains below Vₘₐₓ, the beneficial effects of the present invention can still be obtained, including improvement of times needed to achieve high % SOC. A not-to-scale exemplary representation of the voltage and current behavior using a fixed incremental voltage pulse in this is illustrated in FIG. 4a.

In some aspects, the fast charge stage of the inventive method can be terminated or restricted when the measured voltage pulse to be applied substantially reaches Vₘₐₓ for the respective battery. If the charge is restricted, the charging rate will be slower than if the charging process is permitted to proceed without restriction, however, charging rates will still exceed those attainable with conventional CC/CV charging. In accordance with this aspect, the voltage applied substantially does not exceed the specified Vₘₐₓ of the battery under charge. A not-to-scale exemplary representation of the voltage and current behavior using feedback of I_{Batt} or I_{BattCavg} to adjust incremental voltage is illustrated in FIG. 4b.

In separate aspects, the inventive charging pulse can be terminated or restricted when the battery has reached at least about 60% or about 70% or about 75% or about 80% or about 85% or about 90% SOC. At this point, a voltage limited stage can commence if desired as a form of restricted continuation of charging. Such a voltage-limited stage can be omitted and the battery process terminated if it is deemed suitable to use the battery that is less than about 100% SOC. A partial application of the inventive charging pulse with or without a subsequent constant voltage stage could be desirable to reduce battery damage over time in comparison to that seen from application of a prior art constant current charging. In laymen's terms, the inventive charging process can be termed a “kinder and gentler” charging process.

One can use any of a myriad of pulse shapes to provide features of the inventive charging pulse of the present invention. It should be noted that since dissipated power is proportional to the square of offset voltage but only proportional to the width of a pulse, minimization of dissipated parasitic power means minimization of RMS pulse height across any given pulse period. For the same cycle average current I_{BattCavg} within a pulse period, the minimum RMS pulse height can be achieved with application of a rectangular pulse of the maximum allowable ON-time width. In some aspects, appropriate pulse shapes comprise those that suitably provide an offset voltage beyond OCVᵢₙₛₜ during the ON-time that is less than the target value. In further aspects, constant voltage pulses are particularly suitable for use herein. A not-to-scale exemplary representation of the voltage and current behavior for a non-rectangular/square pulse shape is illustrated in FIG. 4c.

In one aspect, the charging process can be terminated by applying a limit to sensed average current and average voltage and not to the instantaneous current and instantaneous voltage. Any of a number of methods exists and are appropriate for determining the time to terminate the charging process, so determining time to terminate the charging process and terminating the process are known to those of ordinary skill in the art. Similarly, methods for sensing average current and average voltage are known and consequently are known to those of ordinary skill in the art.

Throughout the fast charging stage and voltage limited charging stage, each charging pulse maximum voltage during an ON-time can be a function of a charge increment strategy and the battery terminal voltage during a preceding OFF-time can be subject to a maximum voltage limitation. Accordingly, the battery charger of the present invention, as well as the processes used for charging, can, in some aspects, be dynamically dependent upon period-to-period feedback from the battery.

At low % SOC the Rₛ may change quickly. In some aspects, at low % SOC, for example, less than about 20% or less than about 10% SOC, it could be helpful to closely monitor the series resistance behavior to ensure that the amount of offset voltage applied to the battery under charge is as close as possible to the minimum amount necessary to effect efficient charge. Such monitoring can be in accordance with known methods as would be known to one of ordinary skill in the art. In some implementations, monitoring of series resistance can be useful during all or part of the charging process.

Yet further, in the inventive charging methods there may be substantially no need to change modes such as by moving from average current charging to average voltage charging, because, in some aspects, the present invention can automatically limit the target battery terminal voltage as appropriate to yield the target battery terminal voltage.

The charging processes and systems incorporating such processes include a wide variety of Li-ion batteries including lithium cobalt oxide, lithium manganese dioxide, lithium iron phosphate, and lithium iron disulfide etc. It should be noted that some fast charging Li-ion chemistries do exist today. For example, lithium titanate is reported to allow charging as fast as 10 C. Such fast charging batteries nonetheless result in lower energy densities. In other words, they do not provide as energy per unit of weight as do other Li-ion battery types.

As would be recognized by one of ordinary skill in the art, the operating voltage characteristics of a particular Li-ion cell will be a function of the anode and cathode materials combined to form the cell. For example, the reported voltage for a lithium cobalt oxide cell comprising a carbon anode is about 3.8 V. But for a cell comprising lithium titanate as the anode, the reported voltage is only about 1.9 V when the cathode is lithium iron phosphate and about 2.5 V when the cathode is cobalt. The higher voltage of the lithium cobalt oxide cell brings higher energy density, but fewer safety features—including lesser ability to accept faster charging. In contrast, cells with lower operating voltage like lithium titanate have better safety features, such as safer fast charging. Generally speaking, Li-ion “power” batteries have lower operating voltages and can accept prior art charges at higher rates, such as greater than about 2 C for at least some of the charging process. Li-ion “energy” batteries have higher operating voltages and are generally not charged for extended periods at rate above about 1 C unless safety and cooling systems are included, such as that disclosed in U.S. Pat. No. 8,263,250, previously incorporated by reference.

In the present invention, it has surprisingly been found that safe and generally non-damaging fast charging can be applied to Li-ion batteries having operating voltages of greater than about 3.0 V, or greater than about 3.2 V. Such batteries include, for example, lithium iron phosphate/graphite (≈3.2 V), lithium manganese oxide/graphite (≈3.7 V), lithium nickel cobalt aluminum oxide/graphite (≈3.6 V), lithium nickel manganese cobalt oxide/graphite (≈3.65 V or more) and lithium cobalt oxide/graphite (≈3.8 V). In further aspects, the present invention does not include lithium titanate and similar Li-ion battery chemistries having operating voltages of less than about 3.0 V or less than about 3.2 V.

The battery charger systems of the present invention, as well as the attendant processes and methods, can be utilized in conjunction with one or more existing battery management systems. Such battery management systems, which generally utilize integrated circuitry to control power management during battery charging, are commonly incorporated in modern electronic devices and other products that are powered by batteries.

Moreover, the present invention can be utilized with, or operationally incorporated within, one or more adaptive battery charging techniques. Such adaptive methods are disclosed, for examples, in US Patent Publication No. 2011/0285356, the disclosure of which is incorporated herein in its entirety.

An overall charging system and process can include the invented charger and method in conjunction with higher-level charging system process controls. FIG. 5 is a block diagram of an exemplary implementation of an inventive battery charger system with interface points for supervisory charging system process controls, but does not show the details of the higher-level process controls, as they do not comprise part of the present invention.

For example, as shown in FIG. 5, a battery charger 10 according to the present invention for suitably charging battery 50 can include about five internal functional subsystems: OCV estimation/sample 100, offset voltage reference 200, voltage summation 300, target battery voltage limitation 400 and power stage 500, each of which may or may not be implemented as discrete physical entities, depending upon economic and space considerations.

FIG. 6 illustrates a suitable implementation of the OCVᵢₙₛₜ estimation or sampling subsystem 100 having the following features: battery voltage buffer 110, D_{pulldown} 115, Rₚᵤₗₗ₋ᵤₚ 120, C_{hold} 125, C_{hold} voltage buffer 130, D_{track} 135, R_{pulldown} 140 and voltage buffer 145. In use, implementation of the OCVᵢₙₛₜ estimation or sampling subsystem 100 will provide, for example, an OCV estimation. In FIG. 6, the OCVᵢₙₛₜ estimation or sampling subsystem 100 can provide the battery charger 10 (not shown) with an estimate of the battery OCVᵢₙₛₜ as practicably close in time as possible to the end of a periodic OFF-time. Estimation can be through battery terminal voltage minimum-tracking or through use of a sample-hold that obtains a sample of the battery terminal voltage or other methods known to those of skill in the art. The specific components suitable for a specific implementation will depend, in part, on how accurate the OCVᵢₙₛₜ estimation is desired to be in a particular circumstance, as well as the desired cost and space available in a particular use case.

Voltage minimum tracking generally requires no sample-hold clock synchronization and can be implemented through use of analog circuits or microcontroller analog-to-digital sampling and subsequent data processing, but estimation accuracy requires design consideration for chosen charging ON-time.

While use of a sample-hold requires timing control for sampling, sample-hold circuits and associate timing controls are commonly utilized in low-cost microcontrollers and hold behavior can be less sensitive to variations in chosen charging ON-times. If the overall charging system will include a microcontroller, that microcontroller may already include timing controls for data sampling, and the sampling and conversion yields a digital number handy for use in other decision-making. Microcontrollers suitable for use in a battery charger working in accordance with the present invention are available from any of a number of electronic device manufacturers, including but not limited to Analog Devices, Atmel, Cypress Semiconductor, Freescale Semiconductor, Infineon, Samsung, Texas instruments, ST Microelectronics.

Referring to FIG. 7, in an exemplary configuration of a suitable charging system in accordance with the present invention, the offset voltage reference system 200 can comprise voltage reference 205, R_{VrefDivider1} 210, R_{VrefDivider2}, Rᵢₛₒₗₐₜₒᵣ 220, offset voltage reference buffer 225 and offset voltage reference input 230. The implementation in FIG. 7 of the offset voltage reference subsystem 200 comprises a default constant voltage reference and includes a provision for application of an optional overriding external offset voltage reference level. In FIG. 7, the offset reference subsystem 200 can determine the offset voltage during the charging period ON-time that the charger will impose on the battery above and beyond the OCVᵢₙₛₜ estimate obtained at the end of a previous charging OFF-time, that is, during a previous trough. In one aspect, the offset voltage reference comprises a constant, or substantially constant, incremental voltage whose value can be determined during design of the charger and can be dependent, in part, upon the target maximum average charging current, an approximation of the battery impedance component comprised of battery electrical connection interface resistance and battery electrolyte resistance, and a target for battery power dissipation during charging at the target maximum average charging current.

Implementations of the battery charger 10, and attendant processes that are in analog form can be, but are not limited, a simple voltage reference, for which a myriad of implementation options are known. Implementations in microprocessor- or microcontroller-based forms can, for example, comprise a constant reference parameter in software or an analog voltage reference read by an analog-to-digital converter.

The offset voltage reference subsystem 200 can also include provision for adjustment of the offset voltage magnitude in order to compensate for battery impedance variations in end-products whose batteries are replaceable by the end-product user.

In some aspects, adjustment of the offset voltage magnitude may be desirable in order to compensate for variations in average charging current. Adjustment of the offset voltage magnitude also may be desirable in order to compensate for other system behavioral variations, such as variation in thermal behavior. Any of a number of techniques can be used to determine the magnitude of offset voltage magnitude adjustment, if such adjustment is desired. In some aspects, the inventive battery charger system, as well as attendant processes and methods, can include the ability to adjust the magnitude but does not include the in-process techniques for determining the amount of adjustment.

For analog implementations, such adjustment ability may include, but is not limited to, inclusion of an augmenting summation or differential amplifier and associated analog filters and buffers that facilitate the scaling and summing or subtracting of signals inputs to said augmenting amplifiers with a nominal offset voltage reference level and thus effect adjustment of the offset voltage magnitude reference. For example, designers of low-power analog implementations may choose to scale analog signal levels to be as low as possible in order to minimize charging circuit power dissipation and then scale up only the final power stage output voltage to a level suitable for battery charging. The level of such scaling may be dependent upon application-specific details, such as available lower-level power supply levels, but the scaling in itself does not generally change the logic of methodology. As another example, many charging process controllers can include features to request a lower charging current in the event of detection of overheating either in the charging circuit or the battery. The request can be of a proportional level but often takes the form of discrete levels. In some implementations of the inventive process, the exact nature of or motivation for a corresponding level of offset voltage magnitude adjustment may not be determined. For some digital implementations, such as those including use of a microprocessor or microcontroller in order to implement the offset voltage reference subsystem, adjustments include, but are not limited to, an adjustment variable that is added to or subtracted from a nominal offset voltage magnitude or nominal offset voltage scale factor. A suitable example for such a scenario would be the software implementation of the offset voltage magnitude adjustment due to detection of process thermal events.

In further aspects, the voltage summation 300 and limitation subsystem 400 can determine the target battery terminal voltage to be applied during charging pulse ON-time. In this regard, as shown in FIG. 8, the voltage summation subsystem 300 provides a nominal target battery terminal voltage that can be, for example the [scaled] sum of the offset reference and the OCVᵢₙₛₜ estimate from a proceeding proximate or an immediately preceding charging pulse OFF-time. The voltage limitation subsystem 400 (see FIG. 9) can then assist in mitigating violation of a relevant maximum battery terminal voltage, Vₘₐₓ, by performing a limiting operation after the summation of the offset reference and the OCVᵢₙₛₜ estimate, so that the output of the limiting operation will be substantially no higher than Vₘₐₓ. The output of the limiting operation can be the target battery terminal voltage or a scaled proxy thereof. Alternatively, the functionality of voltage limitation subsystem 400 can also be imposed on the output of the power stage. Numerous methods for doing so exist, such as those commonly used to protect sensitive electronics systems and/or components from power supply spikes or surges. Use of this alternative location of limiting function can result in the need for components that can divert higher current, so the location of limitation can, in some aspects, be upstream of the power stage in the low-power control computation portion of the invented process.

In a further implementation, voltage summation in analog form can be, but is not limited to, use of operational amplifier summation circuits. FIG. 8 shows the schematic diagram of an analog circuit implementation of a voltage summation subsystem. Referring to FIG. 8, in an exemplary implementation, voltage summation 300 can comprise the following features: Rₛᵤₘ₂ 305, Rₛᵤₘ₂ 310, Rₛᵤₘ₁ 315, Rₛᵤₘ₁ 320, Rₛᵤₘ₁ 325, summation amplifier/buffer 330, Rₛᵤₘ₂ 335 and nominal target voltage 340. Voltage limitation in analog form can be achieved by applying to the output of the voltage summation circuit any of a number of known voltage clamping circuits. FIG. 9 shows the schematic diagram of an analog circuit implementation of a voltage limitation subsystem that also provides a scaled-down proxy for the target battery terminal voltage in order to avoid exceeding the allowable input common mode voltage range of the power stage. Referring to FIG. 9, an exemplary implementation of the voltage limitation subsystem comprises D_{clamp} 405, clamp voltage buffer 410, R_{Vclampdivider1} 415, R_{Vclampdivider2} 420, R_{VTgtdivider1} 425 and R_{VTgtdivider2} 430. Voltage summation in microprocessor/microcontroller implementations generally comprises the summing of two variables in software. Voltage limitation in microprocessor/microcontroller aspects generally comprises relatively simple comparison logic in software that assigns an ON-time terminal voltage variable the lower value between the nominal target battery terminal voltage and the reference maximum.

The power stage of the invention can provide to a battery under charge sufficient to achieve the target battery terminal voltage during the relevant charging pulse ON-time, and can present to the battery the nature of an open circuit during charging pulse OFF-time. One aspect of the power stage during the charging pulse ON-time can be that of a source that does not attempt to instantaneously impose a current on the battery. This can be due, for example, to the presence of inductance(s) in the internal impedance of many batteries. Imposition of a sudden current pulse upon such inductances can result in battery terminal voltage transients. For charging pulses associated with high charging rates, such resultant battery voltage transients can exceed the Vₘₐₓ limit. Accordingly, it can be beneficial for the battery charger power stage to comprise primarily or comprise exclusively a voltage source that induces a charging current pulse.

The power stage during the charging pulse OFF-time can be useful for at least three reasons. First, the power stage can implement open circuit behavior during the periodic charging pulse OFF-times. As a result, the battery under charge has time to relax and for the capacitive features to suitably discharge during the OFF-times the concentrations of charge and ions that may have accumulated during the charging pulse ON-times. Presentation of an open circuit can assist in the discharge of accumulated charge that can flow into the battery, and not back out into the charger. Second, the power stage can implement open circuit behavior for termination of the charging process as can be directed by an external system-level process oversight control. Third, the power stage of an open circuit behavior can facilitate non-termination pauses in a charging process that an external system process control may deem necessary due to process needs, such as, but not limited to, a need to temporarily suspend charging upon detection of excessive battery or charger temperatures.

A useful implementation of a power stage can be a switchmode amplifier or power converter with an output during ON-time that tracks the target battery terminal voltage and whose switchmode output includes the ability to implement the OFF-time open circuit behavior. The use of switchmode output converters in battery chargers is already widespread in practice. Alternatively, a switchmode amplifier or converter can be used, where an output ripple remains small relative to an output voltage and current from the amplifier or converter remains continuously on (otherwise known as “continuous mode”) until the end of process. In one aspect of the present invention, the amplifier or converter operational frequency (50 kHz or higher, and not uncommonly over 1 MHz) can be implemented to be sufficiently high to achieve small output ripple, but the maintenance or following of the output voltage generally only occurs during charging pulse ON-time. During charging pulse OFF-time, the switchmode amplifier or converter generally sources substantially no current and consequently revisits discontinuous current delivery at the much lower frequency (for example, about 10 kHz or lower) corresponding to the charging pulse period (for example, about 100 μs to about 100 ms).

Use of a switchmode power stage, while efficient and common, can provide the need to account for ON-time battery voltage ripple. In various aspects, the sum total voltage of the target battery terminal voltage plus the switchmode output voltage ripple can be maintained to be substantially no greater than Vₘₐₓ. FIG. 10 shows a schematic diagram of an exemplary power stage implementation 500 that utilizes an analog amplifier and a unipolar common collector power follower stage. Referring to FIG. 10, exemplary power stage 500 comprises: summation amplifier/buffer 505, R_{VTgtDivider1} 510, R_{VTgtDivider2} 515, power driver 520, flyback diode D_{Flyback} 525, R_{CurrentSense} 530, periodic switching source 535 and open collector switch 540.

The particular exemplary implementation in FIG. 10 includes gain-setting resistors R_{VTgtDivider1} 510 and R_{VTgtDivider2} 515 in order to provide a scale-up gain to compensate for the scale-down of target battery terminal voltage from the voltage limitation subsystem of FIG. 9. An open-collector pull-down circuit controlled by a timing circuit can either allow the amplifier to follow the target battery terminal voltage during charging pulse ON-time or cause the amplifier to attempt replication of a voltage lower than the battery OCVᵢₙₛₜ during charging pulse OFF-time. The latter situation will cause the unipolar power driver 520 to switch off when the amplifier output voltage drops lower than battery OCVᵢₙₛₜ, and thus the amplifier and unipolar driver generally approximate open circuit switch behavior when the charging pulse is OFF. The particular implementation in FIG. 10 also includes an optional high-side current sense resistor, R_{CurrentSense} 530, between the collector of the power follower stage and the circuit power supply. Should one desire to measure ON-time current in order to adjust the offset voltage, the voltage across R_{CurrentSense} 530 is proportional to current delivered by the power follower stage and can be used as input to compensating feedback circuitry, and this current sensing arrangement is one of several ways familiar to those knowledgeable in the art. Such an implementation of a power stage is fairly straightforward because it can implement the OFF-time switch functionality and poses lower probability of obtaining ON-time voltage ripple whose maximum exceeds Vₘₐₓ. Nonetheless, an analog power stage can be less efficient and can be likely to dissipate more heat in a battery charger.

Irrespective of whether the power stage comprises analog or digital implementation, it can be beneficial to incorporate protection for the switch device against flyback currents from battery internal inductances that might occur during the transition from being a low-impedance ON-time voltage source to being a high-impedance OFF-time open circuit. Such protection appears in most switchmode power converters, but is not always present in analog output stages. Due to impedance switching nature, various implementations of the battery charger systems of the present invention, as well as the attendant processes and methods, can include output flyback protection, such as flyback diode D_{Flyback} 525, as a feature. Also irrespective of whether the power stage comprises analog or digital implementation, target battery terminal voltage limiting subsystem can be included with the power stage, as opposed to including that functionality with the offset voltage summation subsystem.

The inventive charging process may also be implemented in a printed circuit board configuration. Methods to fabricate printed circuit boards suitable to generate and apply the inventive charging pulse are known to those of ordinary skill in the art. Such printed circuit board implementations could be particularly well-suited for high-volume, low cost applications, such as used with mobile devices such, such as smartphones, tablets and other such devices.

The inventive charging process may be implemented using algorithms suitable for generating and providing the inventive charging processes. In other words, an algorithm configured with componentry suitable to provide a charging rate of at least about 1 C, wherein such high charging rate can be applied until the battery cell reaches at least about 80% or about 90% or about 95% SOC substantially without exceeding the cell Vₘₐₓ. Such algorithms may be deliverable to/implemented by a processing device which may include any existing electronic control unit or dedicated electronic control unit, in many forms including, but not limited to, information permanently stored on non-writable storage media such as ROM devices and information alterably stored on writeable storage media such as floppy disks, magnetic tapes, CDs, RAM devices, and other magnetic and optical media. Such algorithms may also be implemented in a software executable object. The algorithms may also be embodied in whole or in part using suitable hardware components, such as Application Specific Integrated Circuits (ASICs), Field-Programmable Gate Arrays (FPGAs), state machines, controllers or hardware components or devices, or a combination of hardware, software and firmware components.

### EXAMPLES

The following Examples are put forth so as to provide those of ordinary skill in the art with a complete disclosure and description of how the present invention is practiced, and associated processes and methods are constructed, used, and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is as specified or is at ambient temperature, and pressure is at or near atmospheric.

Examples 1-3 below were charged using the exemplary inventive charging circuit illustrated in FIG. 5. The power supply used was a Tekpower HY 1803D variable voltage power supply (Amazon.com). A 46-Range Digital Multimeter: 22-812 (RadioShack.com) was used to measure voltage. The batteries used were as indicated in the Examples.

### Example 1

### Example 1a

Experimental (non-commercial) Li-ion 1000 mAh 3.7V Li-ion polymer pouch cells intended for use in mobile devices (e.g., “energy” cells) were charged using the inventive charging process so as to provide an average charging rate of slightly more than about 1 C using the circuit configuration set out in FIG. 5. The starting voltage of the battery was about 3.0 V, signifying an approximately fully discharged cell. The offset voltage used in the inventive charging process was 300 mV, the duty cycle (ON-time/OFF-time) was 90/10% and the frequency of the voltage pulse was 100 Hz. The charge termination point, based on V_{Batt} was 4.5 V which represented the sum of the voltage offset (300 mV) and the actual cell Vₘₐₓ (4.2 V). A 1 C discharge was used to measure the capacity of the battery resulting from charging.

### Example 1b

A comparison charging process was conducted on the same type of cell as used in Example 1a having an about 3.0 V starting voltage. This battery was charged using CC/CV method applied with a 1 C constant current portion, followed by application of constant voltage applied when the voltage reached Vₘₐₓ. A 1 C discharge was used to measure the capacity of the battery resulting from the charging step.

### Example 1

### Results

As shown by comparison of FIGS. 11 and 12, the inventive charging process of Example 1a shows markedly different charging behavior vs. the conventional CC/CV charging of FIG. 12, as well that process shown generally in the prior art (see e.g., FIG. 1). In contrast to application of the conventional CC/CV charge, the inventive charging process allows application of a high charge rate during the entire charge period without the appearance of the typical voltage response that requires tapering of the charging rate when using conventional CC/CV charging. Significantly, in Example 1a the tested battery achieves 100% SOC in less than 1 hour with OCVᵢₙₛₜ (i.e., the lower line in FIG. 11 denoted “cell voltage”) substantially remaining below Vₘₐₓ for this cell (4.2 V). When the battery charged with the inventive method was discharged, the capacity of this battery was virtually identical to that of the reference battery charged by a CC/CV process in Example 1b. These tests indicate that the inventive charging process can provide a full charge in less than about 60 minutes vs. about 155 for the CC/CV charged reference—which is almost 3 times faster. A chart comparing charging times between Examples 1a and 1b is in FIG. 13.

Put another way, the battery charged using the inventive charging process in Example 1a appears to accept charge applied at a rate of about 1.1 C for the full charging time, with the characteristic voltage response from conventional constant current charging being notably absent. This indicates that this Li-ion cell can achieve 100% SOC in less than about 1 hour substantially without exceeding the cell's Vₘₐₓ.

### Example 2

### Example 2a

The power supply was configured to apply an average charging rate of 2 C from the circuit configuration of FIG. 5. One of the two Li-ion battery cells was removed from a LiPo 7.4V 1000 mAh Novus 200 FP Li-ion battery pack (HobbyZone.com) intended for use in a radio controlled helicopter for use in this Example 2a. The starting voltage was approximately 3.0 V. The offset voltage for the inventive charging process was 300 mV, the duty cycle (ON-time/OFF-time) was 90/10% and the frequency of the voltage pulse was 100 Hz. The charge termination point was 4.5 V (V_{Batt}) which represented the sum of voltage offset (300 mV) and the actual cell Vₘₐₓ (4.2 V). A 1 C discharge was used to measure battery capacity from charging.

### Example 2b

A comparison CC/CV process was conducted on the same type of cell as used in Example 2a having an about 3.0 V starting voltage. This cell was charged using constant current applied at 2 C, followed by application of constant voltage applied when the voltage reached Vₘₐₓ. A 1 C discharge was used to measure the capacity of the battery from charging.

### Example 2

### Results

As shown by comparing of FIGS. 14 and 15, the inventive charging process of Example 2a shows markedly different charging behavior vs. the conventional CC/CV charging shown in FIG. 2b. In contrast to application of the conventional CC/CV charging process where the CC portion is applied at 2 C, the inventive 2 C charging process allows application of a high charging rate during the substantially the entire charging period without the typical voltage response that requires tapering of the current when using conventional CC/CV charging. Significantly, in Example 2a the tested batteries achieve 100% SOC in about ½ hour with OCVᵢₙₛₜ, (i.e., the line denoted “cell voltage” in FIG. 14) remaining at all times below Vₘₐₓ. When the battery charged with the inventive method was discharged at 1 C, the capacity of this battery was virtually identical to that of the reference battery charged by CC/CV in Example 2b. These tests indicate that the inventive charging process can provide a full charge in about 30 minutes vs. about 1 hour for the CC/CV charged reference substantially without the cell exceeding the Vₘₐₓ for this cell. A comparison of charging times is presented in FIG. 16.

Notably, little to no temperature increase was observed with the inventive charging process in both Examples 1a and 2a. Such absence of temperature increase could indicate that the inventive charging process could provide improved energy efficiency since the absence of heat would signal that less energy wasted as heat vs. conventional charging processes.

### Example 3

### Example 3a

A Heli-MaxLiPo 1S 3.7V 250 mAh 1SQ Quadcopter HMXP1009 cell (HobbyZone.com) was tested at a 4 C average charging rate using the circuit configuration of FIG. 5. The cell had a starting voltage of about 3.0 V. The offset voltage in the inventive charging process was 300 mV, the duty cycle (ON-time/OFF-time) was 90/10% and the frequency of the voltage pulse was 100 Hz. The charge termination point was 4.5 V which represented the sum of the voltage offset (300 mV) and the actual cell Vₘₐₓ (4.2 V). A 1 C discharge was used to measure the capacity of the battery resulting from the charging step.

### Example 3b

A comparison CC/CV charging process was conducted on the same type of cell as used in Example 2a having an about 3.0 V starting voltage. This battery was charged using constant current applied at 4 C, followed by application of constant voltage when the voltage reached Vₘₐₓ. A 1 C discharge was used to measure the capacity of the battery after charging.

### Example 3

### Results

As shown by comparing of FIGS. 17 and 18, the inventive charging process of Example 3a shows markedly different charging behavior vs. conventional CC/CV charging at the same rate. In contrast to application of the conventional CC/CV charging process where the CC portion is applied at 4 C, the inventive 4 C charging process allows application of a high rate charge substantially during the entire charge period without appearance of the typical voltage response that requires tapering. When a 4 C charging rate is applied to the battery using constant current in Example 3b, the current begins to taper at about 12 minutes, signifying that the anode cannot continue to accept charge at this rate. Significantly, in Example 3a the tested batteries achieve 100% SOC in 15 minutes with OCVᵢₙₛₜ, (i.e., the line denoted “cell voltage” in FIG. 17) substantially remaining at all times below Vₘₐₓ. When the battery charged with the inventive method was discharged at 1 C, the capacity of this battery was virtually identical to that of the reference battery charged by CC/CV in Example 3b. These tests indicate that the inventive charging process can provide a full charge in about 15 minutes vs. more than ½ hour for the CC/CV charged reference, substantially without the cell exceeding Vₘₐₓ.

### Example 4

### Prophetic

Tesla Motors® has recently introduced a DC fast charging infrastructure on interstate highways in the US. Tesla Motors has reported that the Model S 85 kWh battery, which has a reported 300 mile range of 100% SOC, can be charged to 50% in 20 minutes, 80% in 40 minutes, and 100% in 75 minutes using the company's SuperCharger charging system. This translates to an about 1.5 C charging for the first 50% SOC, about 0.9 C for the next 20 minutes and about 0.34 C for the final 35 minutes. It can then be inferred that the reduction in charging rate seen after 20 minutes, and the more marked reduction after 40 minutes results from the characteristic voltage rise from this prior art fast charging process.

As disclosed herein, the inventive charging process substantially does not cause the characteristic voltage rise seen with conventional DC fast charging. In a prophetic example, the inventive charging process could reduce the time to charge the Tesla Model S 85 kWh to 100% SOC from the 75 minutes required currently to 40 minutes and reduce the time needed to achieve 80% SOC from 40 minutes to 30 minutes or possibly less. A graph comparing the current Tesla Motors SuperCharger battery charging system to prophetic results with the inventive charging process applied using the same charging rate is shown in FIG. 19. The time savings would likely be comparable in other vehicles, such as the Nissan Leaf® and Chevy Spark®.

While the invention has been described in detail, various modifications to the specific implementations illustrated will be readily apparent to those of skill in the art. Such modifications are within the spirit and scope of the present invention defined in the appended claims. The following are non-limiting examples of such modifications:
1. A method of charging Li-ion batteries comprising:
   a. applying a plurality of charging pulses to a Li-ion battery cell, wherein the battery cell comprises:
      i. a maximum acceptable terminal circuit voltage (Vₘₐₓ);
      ii. a plurality of instantaneous open circuit voltages (Vᵢₙₛₜ),
b. wherein the plurality of charging pulses provides charge to the battery cell at an average C rate of at least about 1 C, and wherein during application of substantially all the plurality of charge pulses substantially all of the plurality of OCVᵢₙₛₜ remain below Vₘₐₓ, thereby allowing the battery to be charged to a state of charge (SOC) of at least about 95% or more in 1 hour or less.
2. The method of embodiment 1, wherein the plurality of charging pulses consists essentially of a voltage pulse.
3. The method of embodiment 1, wherein the plurality of charging pulses each, independently, comprise an offset voltage, a frequency and a duty cycle.
4. The method of embodiment 1, wherein the average C rate is greater than about 1.5 C, wherein the battery cell SOC is at least about 95% or more in about 40 minutes or less.
5. The method of embodiment 1, wherein the average C rate is greater than about 2 C, wherein the battery cell SOC is at least about 95% or more in about 30 minutes or less.
6. The method of embodiment 3, wherein the offset voltage of the plurality of voltage pulses is from about 100 to about 700 mV.
7. The method of embodiment 3, wherein the frequency of the plurality of voltage pulses is from about 1 to about 50 Hz.
8. The method of embodiment 3, wherein the duty cycle of the plurality of voltage pulses is from about 99% to about 80% ON-time.
9. The method of embodiment 1, wherein the battery cell has an operating voltage of at least about 3.0 V.
10. A battery charger system for charging a Li-ion battery cell configured to apply a plurality of charging pulses to a Li-ion battery at an average rate of at least about 1 C, wherein the battery cell comprises:
   i. a maximum acceptable voltage (Vₘₐₓ);
   ii. a plurality of instantaneous open circuit voltages (OCVᵢₙₛₜ),
      wherein the plurality of charging pulses provides charge to the battery cell an average C rate of at least about 1 C, and wherein during application of substantially all the plurality of charge pulses substantially all of the plurality of OCVᵢₙₛₜ remain below Vₘₐₓ, thereby allowing the battery to be charged to a state of charge (SOC) of at least about 95% or more in 1 hour or less.
11. The system of embodiment 10, wherein the plurality of charging pulses provided by the circuitry each, independently, comprise a voltage pulse.
12. The system of embodiment 10, wherein each of the plurality of charging pulses comprise an offset voltage, a frequency and a duty cycle.
13. The system of embodiment 10 configured to provide a charging rate of at least about 1.5 C, wherein the battery cell SOC reaches at least about 95% or more in about 40 minutes or less.
14. The system of embodiment 10 configured to provide a charging rate of at least about 2 C, wherein the battery cell SOC reaches at least about 95% or more in about 30 minutes or less.
15. The system of embodiment 10, wherein the battery cell has an operating voltage of at least about 3.0 V.

Any US patents and patent applications referred to herein are hereby incorporated by reference in their entireties by this reference.

What is claimed is:

1. A process for charging a Li-ion battery cell, wherein the process comprises:
a) providing at least one Li-ion battery cell, wherein the battery cell comprises:
i) a series internal resistance (Rₛ);
ii) a maximum acceptable battery terminal voltage (Vₘₐₓ);
iii) a battery terminal voltage (V_{Batt}); and
iv) an instantaneous open circuit voltage (OCVᵢₙₛₜ);
b) applying to the battery cell a plurality of charging pulses to provide a desired C rate,
i) wherein each charging pulse, independently, comprises an ON-time and an OFF-time, wherein the ON-time follows the OFF-time,
ii) wherein the process during the OFF-time presents to the battery the nature of an open circuit, and
iii) wherein the battery terminal voltage, V_{Batt}, during the ON-time portion of each of the plurality of voltage pulses, independently, is determined according to the formula:
V_{Batt}=I_{Batt}×Rₛ+OCVᵢₙₛₜ
and
I_{Batt}=I_{BattCavg}×(pulse period)/(on-time duration);
where I_{BattCavg} comprises the C rate applied to the battery.

2. The method of claim 1, wherein the plurality of charging pulses is applied to Li-ion battery cell to provide at least about 95% SOC and wherein OCVᵢₙₛₜ substantially does not exceed Vₘₐₓ during application of substantially of the plurality of charging pulses.

3. The method of claim 1, wherein I_{BattCavg} is at least about 1 C, wherein the battery cell SOC is at least about 95% or more in about 60 minutes or less.

4. The method of claim 1, wherein I_{BattCavg} is at least about 1.5 C, wherein the battery cell SOC is at least about 95% or more in about 30 minutes or less.

5. The method of claim 1, wherein OCVᵢₙₛₜ determined by one or more of:
a. sampling one or more times during a trough occurring during each OFF-time; and
b. estimating from measurement of battery terminal voltage during application of the plurality of charging pulses.
